(19) United States
(12) Patent Application Publication
(10) Pub. No.: US 2023/0383723 A1
(43) Pub. Date: Nov. 30, 2023

(54) HYDROELECTRIC ENERGY SYSTEMS AND METHODS FOR MECHANICAL POWER TRANSMISSION AND CONVERSION

(71) Applicant: OCEANA ENERGY COMPANY, Washington, DC (US)

(72) Inventor: Daniel E. POWER, III, Pace, FL (US)

(73) Assignee: OCEANA ENERGY COMPANY, Washington, DC (US)

(21) Appl. No.: 18/250,110

(22) PCT Filed: Nov. 16, 2021
(86) PCT No.: PCT/US21/59497

§ 371 Date: Apr. 21, 2023

Related U.S. Application Data
(60) Provisional application No. 63/114,770, filed on Nov. 17, 2020.

(51) Int. Cl. F03B 17/06

(52) U.S. Cl. CPC F03B 17/061; F05B 2240/932; F05B 2220/706; F05B 2260/4021; F05B 2260/4031

(57) ABSTRACT

A hydroelectric energy system includes a turbine including a stator and a rotor. The rotor is disposed radially outward of the stator and is rotatable around the stator about an axis of rotation. The system also includes a mechanical power conversion assembly including a gear operably coupled to a generator. The system further includes a mechanical power transmission assembly operably coupling the rotor to the gear. The rotor includes a plurality of blades configured to rotate in response to fluid flow interacting with the plurality of blades. The mechanical power conversion assembly is at a location spaced from the axis of rotation by a distance larger than a radial sweep of the blades. The mechanical power transmission assembly is configured to transmit the rotation of the rotor to the gear.

### CROSS-REFERENCE TO RELATED APPLICATION

This application claims priority to U.S. Provisional Patent Application No. 63/114,770, filed Nov. 17, 2020 and entitled “Hydroelectric Energy Systems and Methods Utilizing a Constant Velocity Axle,” the entirety of which is incorporated by reference herein.

### TECHNICAL FIELD

The present disclosure relates generally to hydroelectric energy systems and methods, and more particularly to mechanisms to transmit and convert mechanical energy to electrical energy in such systems.

### INTRODUCTION

The section headings used herein are for organizational purposes only and are not to be construed as limiting the subject matter described in any way.

A hydroelectric energy system may utilize a hydroelectric turbine to generate electricity from the current in a moving body of water (e.g., a river or ocean current) or other fluid source. Tidal power, for example, exploits the movement of water caused by tidal currents, or the rise and fall in sea levels due to tides. As the waters rise and then fall, a flow, or fluid current, is generated. The one-directional flow from other bodies of water, such as, for example, from a river, also creates a current that may be used to generate electricity. Additional forms of differential pressure, such as, for example, that are created by dams, also can cause water to flow and create water speeds sufficient to enable the conversion of the horizontal kinetic energy associated with the water's flow to other useful forms of energy.

Hydroelectric energy which relies on the natural movement of fluid currents, such as those occurring in a body of fluid (e.g., water), is classified as a renewable energy source. Unlike other renewable energy sources, such as wind and solar energy, however, hydroelectric energy is reliably predictable. Water currents are a source of renewable power that is clean, reliable, and predictable years in advance, thereby facilitating integration with existing energy grids. Additionally, by virtue of the basic physical characteristics of water (including, e.g., seawater), namely, its density (which can be 832 times that of air) and its non-compressibility, this medium holds unique “ultra-high-energy-density” potential in comparison to other renewable energy sources for generating renewable energy. This potential is amplified once the volume and flow rates present in many coastal locations and/or useable locations worldwide are factored in.

Hydroelectric energy, therefore, may offer an efficient, long-term source of pollution-free electricity, hydrogen production, and/or other useful forms of energy that can help reduce the world's current reliance upon petroleum, natural gas, and coal. Reduced consumption of fossil fuel resources can in turn help to decrease the output of greenhouse gases into the world's atmosphere.

Electricity generation using hydroelectric turbines (which convert kinetic energy from fluid currents into rotational mechanical energy) is generally known. Examples of such turbines are described, for example, in U.S. Pat. No. 7,453,166 B2, entitled “System for Generating Electricity from Fluid Currents;” U.S. Pat. No. 9,359,991 B2, entitled “Energy Conversion Systems and Methods;” U.S. Pat. No. 10,389,209 B2, entitled “Hydroelectric Turbines, Anchoring Structures, and Related Methods of Assembly,” U.S. Pat. No. 10,544,775 B2, entitled “Hydroelectric Energy Systems, and Related Components and Methods;” and U.S. Patent Application Publication No. 2021-0190032 A1, entitled “Hydroelectric Energy Systems and Methods,” which are incorporated by reference herein. Such turbines can act like underwater windmills and have a relatively low cost and ecological impact. In various hydroelectric turbines, for example, fluid flow interacts with blades that rotate about an axis and that rotation (i.e., rotational mechanical energy) is harnessed to thereby produce electricity or other forms of energy.

Hydroelectric energy systems, however, are generally relatively complex and require custom components and parts that can be costly to produce and maintain. Additional challenges also may arise with accessing the turbines for repair and maintenance once the turbine is submerged and installed, for example, in a moving body of water. Various challenges arise in designing and implementing hydroelectric energy generation systems in view of the turbulent nature of the environments in which they are deployed, such as the one-directional (i.e., uni-directional) river flow or the undulations associated with tidal currents, which can produce non-steady input/output and can accelerate corrosion and fatigue issues of the components of the turbine. Furthermore, various additional challenges may arise regarding protecting such turbines and various components of the hydroelectric energy generation system from floating debris that may be carried in the fluid body in which they are deployed. Moreover, the bodies of water being liquid and in some cases of high mineral or salt content, may further exacerbate corrosion and/or wear on parts of hydroelectric energy system.

It may, therefore, be desirable to provide a hydroelectric energy system having a design that facilitates greater ease of access to its components for repair and maintenance requirements. It may be further desirable to provide a hydroelectric energy system having a design that reduces the risk of corrosion and damage to key components of the system.

### SUMMARY

Exemplary embodiments of the present disclosure may demonstrate one or more of the above-mentioned desirable features. Other features and/or advantages may become apparent from the description that follows.

Additional objects and advantages will be set forth in part in the description which follows, and in part will be obvious from the description, or may be learned by practice of the present teachings. At least some of the objects and advantages of the present disclosure may be realized and attained by means of the elements and combinations particularly pointed out in the appended claims.

In accordance with various exemplary embodiments of the present disclosure, a hydroelectric energy system includes a turbine comprising a stator and a rotor. The rotor is disposed radially outward of the stator and is rotatable around the stator about an axis of rotation. The system may also include a mechanical power conversion assembly including a gear operably coupled to a generator. The system further includes a mechanical power transmission assembly operably coupling the rotor to the gear. The rotor includes a plurality of blades configured to rotate in response to fluid flow interacting with the plurality of blades. The mechanical power conversion assembly is at a location spaced from the axis of rotation by a distance larger than a radial sweep of the blades. The mechanical power transmission assembly is configured to transmit the rotation of the rotor to the gear.

In accordance with various additional exemplary embodiments of the present disclosure, a method of collecting hydroelectric energy includes supporting a turbine in a position submerged within a body of fluid comprising a fluid flow. The turbine comprises a rotor disposed radially outward of a stator and the rotor comprises blades extending radially outward. The method also includes rotating the rotor around the stator about an axis of rotation via the fluid flow interacting with the blades. The method further includes transmitting the rotation of the rotor to a gear supported above the body of fluid. The gear is operatively coupled to a generator supported above the body of fluid.

It is to be understood that both the foregoing general description and the following detailed description are exemplary and explanatory only and are not restrictive of the present disclosure and claims, including equivalents. It should be understood the present disclosure and claims, in their broadest sense, could be practiced without having one or more features of these exemplary aspects and embodiments. For example, those of ordinary skill in the art would understand that the following detailed description related to hydroelectric energy systems and methods are exemplary only, and that the disclosed systems and methods can have various components, which utilize various hydroelectric turbines, mechanical energy transmission components, gear assemblies, and generators to collect, transmit, and convert mechanical energy into electrical energy.

### BRIEF DESCRIPTION OF THE DRAWINGS

The accompanying drawings, which are incorporated in and constitute a part of this specification, illustrate various non-limiting embodiments of the present disclosure and together with the description, serve to explain certain principles. In the drawings:

FIG. 1 is a front view of a hydroelectric energy system in accordance with an embodiment of the present disclosure;

FIG. 2 is a side view of the hydroelectric energy system of FIG. 1;

FIG. 3 is an enlarged, side view of an embodiment of mechanical energy transmission assembly of the hydroelectric energy system of FIG. 1;

FIG. 4A is an enlarged, exploded, detailed view of an embodiment of the CV joint in detail 4-4 of the mechanical energy transmission assembly of FIG. 3;

FIG. 4B is an enlarged, partial, front view of an embodiment of a transition assembly in detail 4-4 of the mechanical energy transmission assembly of FIG. 3;

FIG. 5 is an enlarged, detailed view of an embodiment of the mechanical power conversion assembly in detail 5-5 of the hydroelectric energy system of FIG. 3;

FIG. 6 is a front view of a hydroelectric energy system in accordance with another embodiment of the present disclosure;

FIG. 7 is a side view of the hydroelectric energy system of FIG. 6;

FIG. 8 is an exploded view of an embodiment of a turbine of the hydroelectric energy system of FIG. 6, illustrating components of another embodiment of a mechanical energy transmission assembly of the hydroelectric energy system of FIG. 6;

FIG. 9A is a rear view of an embodiment of a rotating ring of the turbine of FIG. 8;

FIG. 9B is a rear view of an embodiment of a power transmission sprocket of the mechanical energy transmission assembly of FIG. 8;

FIG. 9C is rear view of an embodiment of a backing plate of the mechanical energy transmission assembly of FIG. 8;

FIG. 10 is a partial, front view of the hydroelectric energy system of FIG. 6, with a belt and belt guard in accordance with an embodiment of the present disclosure;

FIG. 11 is a partial side view of the hydroelectric energy system of FIG. 10;

FIG. 12 is a perspective view of an embodiment of a hydroelectric turbine that can be utilized in the hydroelectric energy systems and methods of the present disclosure;

FIG. 13 is a front view of another embodiment of a hydroelectric turbine that can be utilized in the hydroelectric energy systems and methods of the present disclosure;

FIG. 14 is a partial, top view of the belt guard of FIG. 10; and

FIG. 15 is an enlarged, partial view of the belt guard showing detail 15-15 of FIG. 14.

### DESCRIPTION OF EXEMPLARY EMBODIMENTS

The present disclosure solves one or more of the above-mentioned problems and/or achieves one or more of the above-mentioned desirable features. Other features and/or advantages may become apparent from the description which follows.

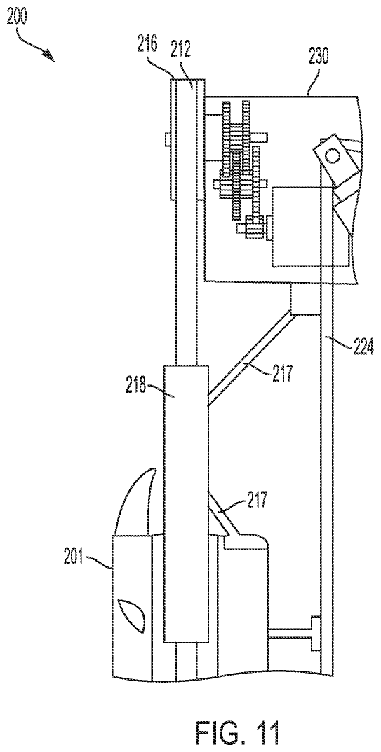

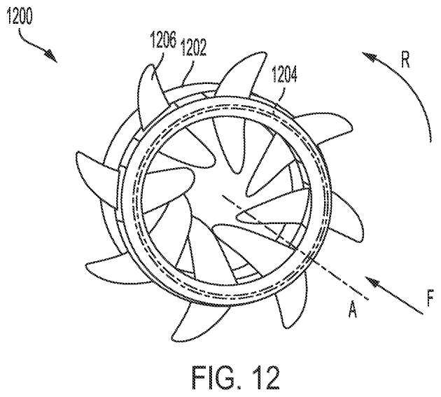

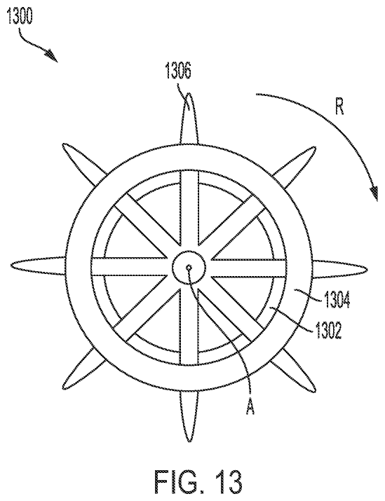

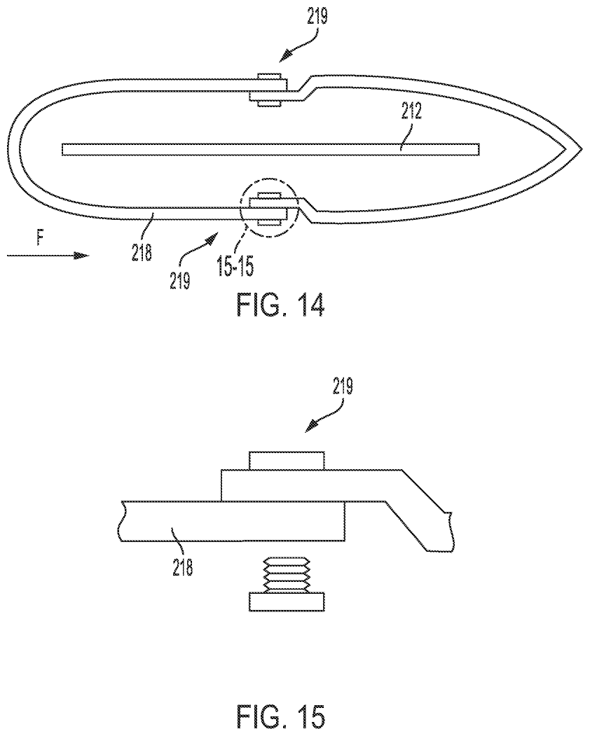

The present disclosure contemplates hydroelectric energy systems that can convert horizontal kinetic energy from fluid flow (e.g., from water currents) into rotational mechanical energy. As illustrated generally in FIGS. 12 and 13, such systems include, for example, a hydroelectric turbine 1200, 1300 comprising a stationary member 1202, 1302 and a rotating member 1204, 1304 that is configured to rotate with respect to the stationary member 1202, 1302 about an axis of rotation A. Turbines in accordance with the present disclosure have a plurality of blades 1206, 1306 having blade portions extending both radially inward and radially outward with respect to the rotating member 1204, 1304, which in various embodiments is a rotating ring structure. In this manner, fluid flow F (see FIG. 12) having a directional component flow generally parallel to the axis of rotation A of the rotating member 1204, 1304 (e.g., into the page in FIG. 13) acts on the blade portions thereby causing the rotating member 1204, 1304 to rotate about the axis of rotation A, for example in direction R in FIGS. 12 and 13. Those having ordinary skill in the art would appreciate that the directions R of FIGS. 12 and 13 may be reversed when current flows in the opposite directions. And in some cases, a bi-directional current may exist and allow the rotation to alternate depending on the direction at a particular time. FIGS. 12 and 13 illustrate nonlimiting embodiments illustrating two configurations of hydroelectric turbines that can be used in the systems and methods of the present disclosure. FIG. 12 illustrates an embodiment of a hydroelectric turbine having an open center configuration and FIG. 13 illustrates an embodiment of a hydroelectric turbine having a centrally located power takeoff system that is disposed along the axis of rotation if the turbine. Other aspects that may be included in such configurations are described, for example, respectively in U.S. Pat. No. 10,389,209 B2, entitled “Hydroelectric Turbines, Anchoring Structures, and Related Methods of Assembly,” and U.S. Patent Application Publication No. 2021-0190032 A1, entitled “Hydroelectric Energy Systems and Methods.” Those of ordinary skill in the art will understand that various configurations of hydroelectric turbines, employing various configurations of stationary members, rotating members, and blades may be used in the contemplated systems and methods to collect rotational mechanical energy from a fluid flow, without departing from the scope of the present disclosure and claims.

The contemplated hydroelectric energy systems may also transfer the mechanical energy collected by the hydroelectric turbines to a gear and generator (e.g., a mechanical power conversion assembly), where the mechanical energy is converted into electricity. In this manner, the kinetic energy in the fluid flow can be directly converted to electricity using, for example, a number of commercially available gear and generator components with which those having ordinary skill in the art would have familiarity. The gears and generators used for electricity production, however, are prone to corrosion and/or damage when positioned in the fluid flow, or otherwise exposed to water in the vicinity of the hydroelectric turbine. Furthermore, positioning such components underwater with the hydroelectric turbine makes it difficult to service such components for repair and maintenance purposes (e.g., when corroded and/or damaged).

Accordingly, to increase accessibility of such components while not interfering with the operation of the turbine, embodiments of the present disclosure contemplate positioning the mechanical power conversion components (e.g., gear assembly and generator) at a position remote from the turbine, for example, at a location spaced from the axis of rotation of the turbine by a distance larger than a radial sweep of the blades of the turbine. The contemplated hydroelectric energy systems and methods are, therefore, configured to transmit the mechanical energy generated by the rotation of the turbine to a mechanical power conversion assembly that is positioned at a location spaced from the axis of rotation by a distance larger than a radial sweep of the blades.

When in use within a body of fluid (e.g., a body of water), to reduce the risk of corrosion and damage to such components, while increasing accessibility and safety for the purposes of maintenance and/or replacement, various embodiments of the present disclosure contemplate hydroelectric energy systems and methods that transmit the mechanical energy generated by the rotation of the hydroelectric turbine to a sealed mechanical power conversion assembly (e.g., gear assembly and generator) that is supported above the water line, where it is then converted to electricity. Accordingly, in various embodiments, the mechanical conversion assembly is placed at a distance (from the axis of rotation of the turbine) that is sufficient to enable the turbine to be submerged in a body of fluid (e.g., body of water) comprising the fluid flow, while the mechanical power conversion assembly is above a surface of the body of fluid

In this manner, hydroelectric energy systems in accordance with the present disclosure, have an architecture that allows energy collection from the fluid current to occur at one location and electricity generation to occur at a different location. More specifically, in embodiments disclosed herein, hydraulic energy is initially collected and converted into mechanical energy by means of the hydroelectric turbine that is submerged in the fluid flow (e.g., current). The resulting mechanical energy (i.e., rotation of the rotating member) is consolidated at an output of the turbine and transmitted through a mechanical power transmission assembly to a mechanical power conversion assembly (e.g., gear and induction generator) housed in a housing above the body of fluid, where it is converted into electrical energy suitable for direct connection to a standard micro-grid.

Using mechanical power transmission assemblies in accordance with various embodiments to transmit the mechanical energy generated at the submerged turbine to a location outside the body of fluid permits the various gearing and electricity generating elements of the hydroelectric energy systems to be protected from the relatively harsh environment (e.g., aqueous environment) of the fluid, as well as facilitating the ability to service such components.

Moreover, as will be better understood from the following description, various embodiments of mechanical power transmission assemblies disclosed herein accommodate for the changing velocities of the rotating turbine that may occur due to the nature of the currents and permit the mechanical energy to be transmitted at a more predictable and uniform manner that is input at the mechanical power conversion assembly

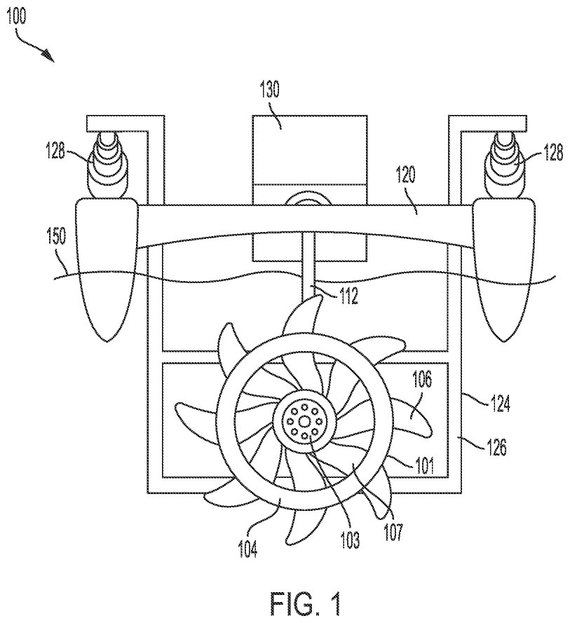

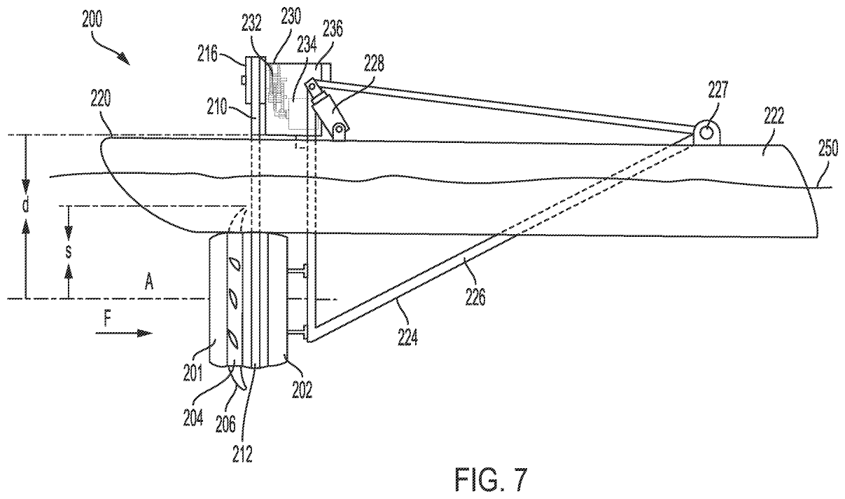

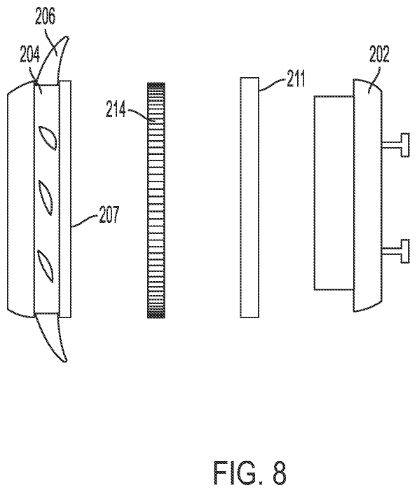

FIGS. 1-5 illustrate one embodiment of a hydroelectric energy system that utilizes a mechanical power transmission assembly and a mechanical power conversion assembly that is positioned at a location spaced from an axis of rotation A of a turbine of the hydroelectric energy system by a distance d larger than a radial sweep s of the blades of the turbine (see FIG. 1). In the embodiment of FIGS. 1-5, which depicts the hydroelectric energy system 100 in use in a body of fluid (e.g., a body of water), the system 100 utilizes a mechanical power transmission assembly and a mechanical power conversion assembly that is at a location out of the body of fluid in which the turbine is submerged. The hydroelectric energy system 100 comprises a mechanical power transmission assembly 110 comprising a constant velocity (CV) axle mechanism 112 that transmits mechanical energy generated at the hydroelectric turbine 101 (from a fluid flowing past the turbine 101 submerged in a body of fluid) to a mechanical power conversion assembly 130 supported above the body of fluid (150 representing a surface of the body of fluid). FIGS. 6-10 illustrate another embodiment of the present disclosure in which a hydroelectric energy system comprises a mechanical power transmission assembly to transmit mechanical energy to a mechanical power conversion assembly that is positioned at a location spaced from an axis of rotation A of a turbine of the hydroelectric energy system by a distance d larger than a radial sweep s of the blades of the turbine (see FIG. 7). In the embodiment of FIGS. 6-10, which depicts the hydroelectric energy system 200 in use in a body of fluid (e.g., a body of water), the system 200 utilizes a mechanical power transmission assembly and a mechanical power conversion assembly that is at a location out of the body of fluid in which the turbine is submerged. The mechanical power transmission assembly comprises a belt 212 that transmits the mechanical energy generated by the submerged and rotating hydroelectric turbine 201 to a mechanical power conversion assembly 230 supported above the body of fluid (the surface of the body of fluid being shown at 250).

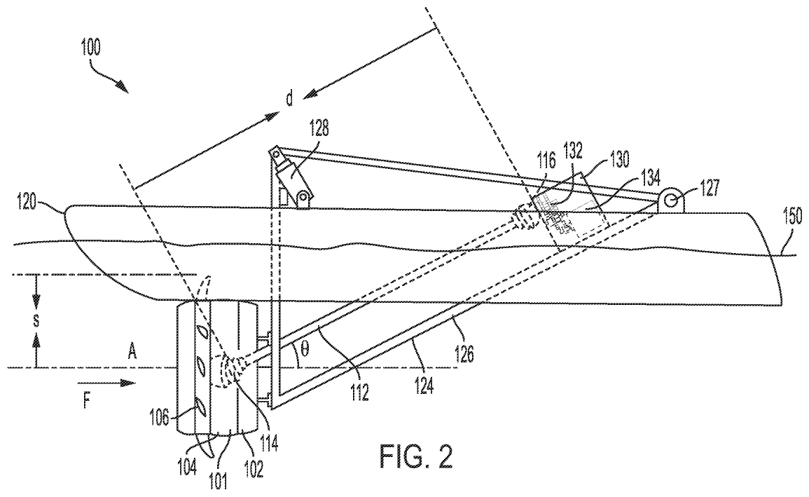

The hydroelectric energy systems 100, 200 further comprise floatation structures 120, 220 that are configured to support the hydroelectric turbines 101, 201 within a fluid flow F (see FIGS. 2 and 7) of the body of fluid (i.e., at a location submerged below the surface 150, 250 of the body of fluid).

Each hydroelectric turbine 101, 201 comprises a stator 102, 202 and a rotor 104, 204, the latter of which includes a plurality of blades 106, 206 configured to interact with a fluid flow F to cause the rotor 104, 204 to rotate. Nonlimiting embodiments of hydroelectric turbines that may be used are described, for example, with reference to FIGS. 12 and 13 above, and in U.S. Pat. No. 7,453,166 B2, entitled “System for Generating Electricity from Fluid Currents;” U.S. Pat. No. 9,359,991 B2, entitled “Energy Conversion Systems and Methods;” U.S. Pat. No. 10,389,209 B2, entitled “Hydroelectric Turbines, Anchoring Structures, and Related Methods of Assembly,” U.S. Pat. No. 10,544,775 B2, entitled “Hydroelectric Energy Systems, and Related Components and Methods,” U.S. Patent Application Publication No. 2021-0190032 A1, entitled “Hydroelectric Energy Systems and Methods,” the contents each of which is incorporated by reference in its entirety herein.

As illustrated best perhaps in FIGS. 2 and 7, the hydroelectric turbine 101, 201 of the hydroelectric energy systems 100, 200 can be suspended under the floatation structure 120, 220 (i.e., within the body of fluid and in the fluid flow F) and the mechanical power conversion assembly 130, 230 is supported above the surface 150, 250 of the fluid body via the floatation structure 120, 220. In accordance with various embodiments, the floatation structure 120, 220 may comprise, for example, a catamaran, hull structure, barge, dock or a variety of other floating platforms. In the embodiment illustrated, the hydroelectric turbine 101, 201 is suspended between hulls 122, 222 of a catamaran via, for example, a support structure 124, 224. The support structure 124, 224 is configured to support the hydroelectric turbine 101, 201 in a fluid body in which the catamaran hulls 122, 222 float, such that a fluid flow having a directional component flow F generally parallel to an axis of rotation A of the rotor 104, 204 may act on blades 106, 206 to cause the rotor 104, 204 to rotate about the axis of rotation A. It would be understood by those of ordinary skill in the art, however, that the turbines of the present disclosure may be configured to operate with various and changing directions of fluid flow and are configured to operate with both the ebb and flow of, for example, tidal currents, as well as currents coming from only one direction, such as, for example, river currents.

In accordance with an embodiment, the support structure 124, 224 is further configured to raise and lower the hydroelectric turbine 101, 201 between a first, deployed position in which the turbine 101, 201 is positioned below the catamaran hulls 122, 222 and in the fluid flow to collect kinetic energy, and a second, stowed position in which the hydroelectric turbine 101, 201 is raised out of the fluid (i.e., above a surface of the body of fluid (e.g., water line) 150, 250) so as to allow for service, repair, and/or maintenance of the turbine and/or maneuvering of the catamaran. Various embodiments of the present disclosure contemplate, for example, suspending the hydroelectric turbine 101, 201 via a hydraulic support structure 124, 224 including a frame 126, 226 that is attached to the hulls 122, 222 of the catamaran via pivots 127, 227 and telescopic hydraulic lifts 128, 228.

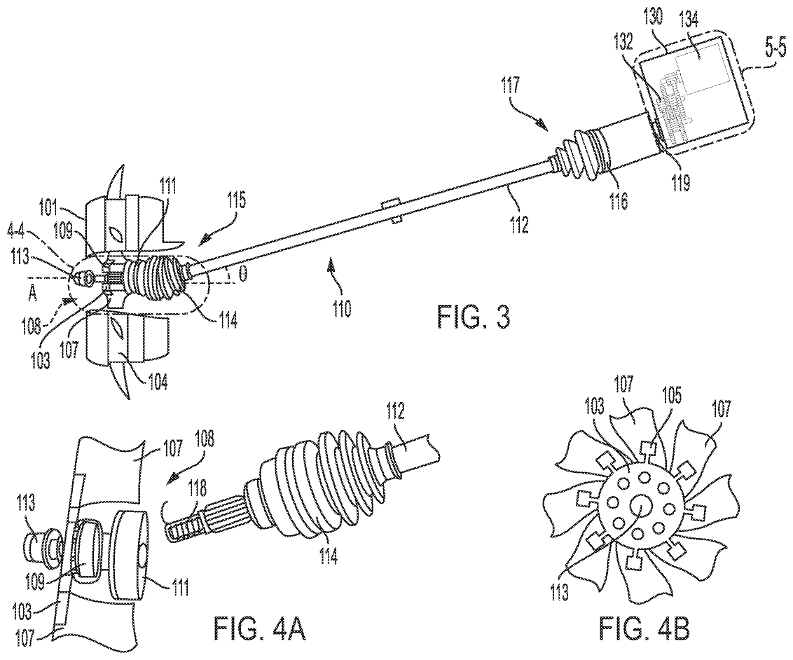

To convert the high torque, low speed power collected by the turbine 101, 201 to a low torque, high speed input suitable for a generator, embodiments of the present disclosure further contemplate utilizing a mechanical power conversion assembly 130, 230, which couples the generator to a gear assembly. With reference to FIGS. 3, 5, and 7, the mechanical power conversion assembly 130, 230 includes a housing 136, 236, which encloses a gear assembly 132, 232 that is operably coupled to a generator 134, 234. In an embodiment, the generator 134, 234 may be an induction generator, which does not require a complicated control system, as known in the art. As above, the housing 136, 236 is supported above the surface 150, 250 of the body of fluid via the floatation structure 120, 220, and the housing 136, 236 is sealed to keep liquid (e.g., rain, water from the fluid in which the floatation structure 120, 220 floats, and/or other moisture) out of the housing 136, 236. In various embodiments, the housing 136, 236 may be supported directly on the hulls 122, 222 of the catamaran floatation structure 120, 220 (see FIGS. 6 and 7), while in other embodiments, the housing 136, 236 may be supported via the frame 126, 226 of the support structure 124, 224 (see FIGS. 1 and 2). In still other embodiments, separate floatation structures can be deployed and coupled together to support the turbine and the energy power conversion assembly.

Those of ordinary skill in the art would understand that the hydroelectric turbines 101, 201, floatation structures 120, 220, support structures 124, 224, and mechanical power conversion assemblies 130, 230 illustrated in the embodiments of FIGS. 1-5 and 6-11, and discussed above, are all exemplary only and not intended to limit the present disclosure and claims. It will be understood that various configurations and/or designs of turbines (i.e., utilizing various configurations of stators, rotors, and blades), may be suspended from various types and/or configurations of floatation structures, via various configurations of support structures. The present disclosure also contemplates various additional devices and methods for deploying/supporting the disclosed hydroelectric energy systems, including suspending the turbine from various additional types of fixed and/or floating structures and anchoring the turbine to the bed of the body of fluid (e.g., anchoring the turbine to the seabed floor instead of suspending the turbine from a floating structure), while supporting the housing and power generation components (i.e., the mechanical power conversion assembly) of the system above the surface of the body of fluid in which the turbine is submerged/anchored.

It will also be understood that various mechanical power conversion assemblies, utilizing various configurations and/or combinations of gears and generators, may be used to convert the rotational mechanical energy collected by the turbine into electricity. Although the illustrated embodiments depict power generation components such as a mechanical gear assembly that is coupled to an induction generator, in another embodiment, the generator may be coupled to a magnetic gear, such as, for example, an orbital magnetic gear, as disclosed in International Patent Application Publication No. WO/2020/118151, entitled “Orbital Magnetic Gear, and Related Systems,” which is incorporated by reference in its entirety herein.

Various exemplary embodiments further contemplate the use of modular architectures employing electrical power generation equipment designed to operate at speeds appropriate for 6 and 8 pole induction motors, e.g., 1200 and 900 rpm. Both types of induction motors are commercially available and come in sizes that are conducive to applications associated with the embodiments of hydroelectric energy systems disclosed herein. While mechanical gears may also be used to convert the low speed, high torque at the turbine to high speed, low torque at the generator, they may be more prone to wear and other damage. Using magnetic gears thus can provide further advantages regarding maintenance and efficiency. As discussed in International Patent Application Publication No. WO/2020/118151, using the magnetic gears can alleviate other issues, such as vibration and friction, that can result in wear and damage.

Further, the use of such magnetic gears may increase the turbine's hydrodynamic power generation efficiency, or power coefficient of the rotating member. Specifically, the magnetic gear may allow for more reliable operations with reduced maintenance and downtime since it is a non-contacting device that requires no lubrication between bearing components and little routine maintenance. In addition, the magnetic gear achieves reduced losses further improving the turbine's efficiency.

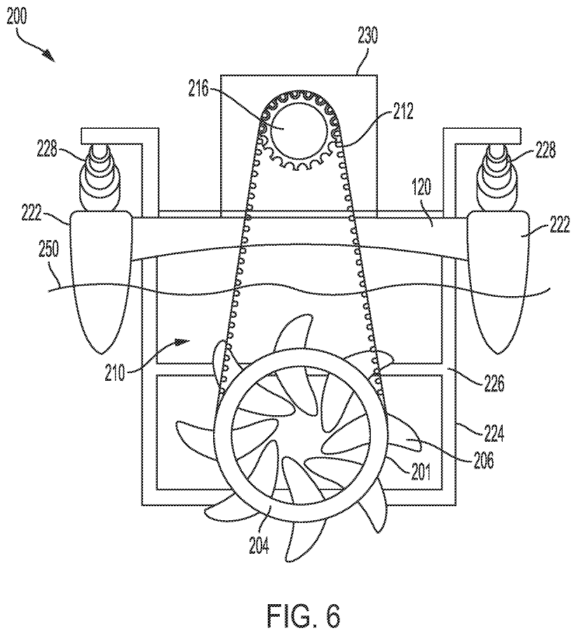

Turning again to the embodiment of FIGS. 1-5, the hydroelectric energy system 100 employs a mechanical power transmission assembly 110 comprising a constant velocity (CV) axle mechanism. More specifically, the CV axle mechanism comprises a CV axle 112 that extends between and is operably coupled to the rotor 104 of the hydroelectric turbine 101 and the gear assembly 132 of the mechanical power conversion assembly 130. In this manner, the CV axle 112 functions as a driveshaft and is configured to transmit the rotation energy of the blades 106 to the mechanical power conversion assembly 130 supported above the surface of the body of fluid, where it is converted to electricity via the generator 134. With reference to FIGS. 3 and 5, the CV axle 112 extends between the rotor 104 and the gear assembly 132 at an angle θ (i.e., relative to an axis of rotation A of the turbine 101) of about 45 degrees or less, such as, for example, an angle θ of about 20 degrees or less. The CV axle mechanism of the mechanical power transmission assembly 110 further comprises at least one constant velocity (CV) joint positioned at an end of the CV axle 112, such as, for example, at least one CV joint positioned to operably couple the CV axle 112 to the rotor 104. In the embodiment of FIGS. 1-5, the mechanical power transmission assembly 110 includes a pair of CV joints positioned on opposite ends of the CV axle 112. A first CV joint 114 can be positioned at a first end 115 of the CV axle 112 and a second CV joint 116 can be positioned at a second, opposite end 117 of the CV axle 112.

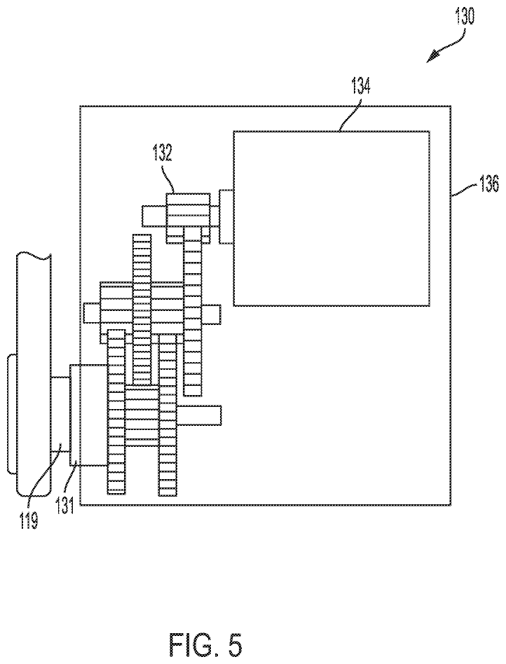

As perhaps best illustrated in FIG. 3, in which a central portion of the turbine 101 has been cut away to better show the connection of the first CV joint 114 to the turbine 101, the first CV joint 114 couples the CV axle 112 to the rotor 104 via, for example, a hub assembly connected to the blades 106. In one embodiment, a hub assembly 108 is centrally located within and coupled to the turbine 101 along the axis of rotation A, such that radially inward extending portions 107 of the blades 106 may each attach to the hub assembly 108. With reference to the enlarged views of FIGS. 4A and 4B, in one embodiment, a transition assembly 103 is, for example, affixed to a central, convergence point of the blade portions 107 (e.g., along the axis of rotation A), and one or more arms 105 of the assembly 103 reach radially outward and are affixed to one or more of the blade portions 107. In various embodiments, the transition assembly 103 may, for example, be attached on and/or embedded into the blades 106 via any methods and/or techniques known in the art, including, for example, via bolting, adhesion, molding and/or an additive manufacturing process. To attach the blades 106 to the hub assembly 108, the hub assembly 108 may be coupled to, for example, bolted, screwed, and/or otherwise secured onto the transition assembly 103.

As illustrated in FIG. 4A, the hub assembly 108 may include a splined hub 109, such as for example, a stainless-steel splined hub as known in the art, that is surrounded by a rubber seal 111 and backed by a nut 113. The splined hub 109 receives a corresponding splined shaft end portion 118 of the CV joint 114 to couple the CV axle 112 to the radially inward extending portions 107 of the blades 106 of the rotor 104.

The second CV joint 116, at the opposite end 117 of the CV axle, couples the CV axle 112 to the gear assembly 132 of the mechanical power conversion assembly 130. In one embodiment, a rotating shaft end portion 119 (see FIGS. 3 and 5) of the CV joint 116 couples to the gear assembly 132 to transfer the rotation of the CV axle 112 (via the rotation of the rotor 104/blades 106) to the gear assembly 132. A sealing member 131, such as, for example, a multiple-lip seal, similar to those used for naval propeller shafts, may be used to keep water (e.g., rain, water from the body of fluid in which the floatation structure 120 floats, and/or other moisture) out of the housing 136 at the point where the rotating shaft 119 joins the housing 136. The CV axle 112, therefore, links the hub assembly 108 of the rotor 104 to the gear assembly 132, allowing rotation of the rotor 104 to be transmitted at a constant rotational speed, via the CV axle 112 and CV joints 114, 116, to an input of the gear assembly 132.

Those of ordinary skill in the art will understand that the CV axle 112 and the CV joints 114 and 116 of the mechanical power transmission assembly 110 are exemplary only, and that various types, numbers, sizes and/or configurations of CV axles and joints may be utilized within the systems and methods of the present disclosure (i.e., based on a particular application) to transmit the mechanical rotational energy collected by the turbine 101 submerged in the body of fluid to a location out and above the surface of the body of fluid. Furthermore, it will be understood that the CV joints 114 and 116 may be respectively coupled to the rotor 104 and the gear assembly 132 via any known coupling mechanisms.

Turning now to the embodiment of FIGS. 6-11, in another embodiment of the present disclosure, the hydroelectric energy system 200 utilizes a mechanical power transmission assembly 210 comprising a belt drive assembly coupling the rotor 204 of the hydroelectric turbine 201 to the gear assembly 232 of the mechanical power conversion assembly 230. In this embodiment, the belt drive assembly thus transmits mechanical rotational energy of the rotor 204 to the mechanical power conversion assembly 230, where it is converted to electricity via the generator 234.

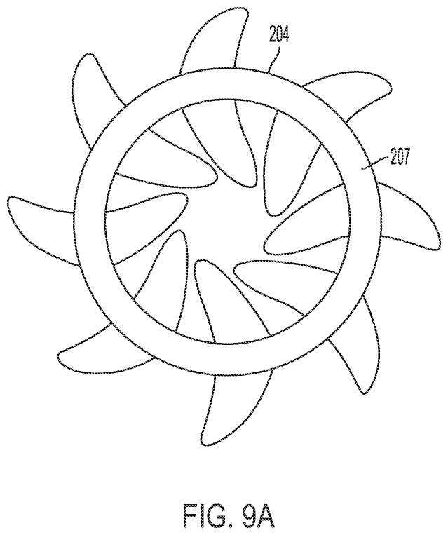

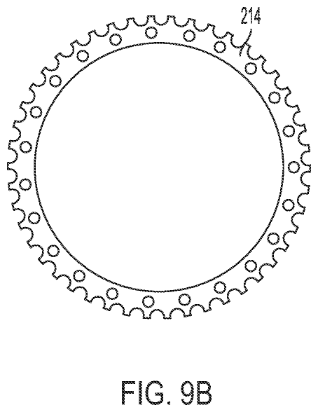

As illustrated in FIGS. 8 and 9, the mechanical power transmission assembly 210 includes a first profiled wheel 214, such as, for example, a first toothed sprocket, that is mounted to the rotor 204 and is configured to mesh with a belt 212. The belt 212 may, for example, comprise a flexible belt with teeth molded onto its inner surface, including, but not limited to, a toothed belt, timing belt, cogged belt, cog belt, or synchronous belt, as known in the art. In various embodiments, the profiled wheel 214 is mounted to the rotor 204 adjacent the blades 206, such that the belt 212 attaches to the rotor 204 at a location that does not interfere with the blades 206 (i.e., is out of a plane of rotation of the blades 206). The wheel 214 may be mounted, for example, to an interior side 207 of the rotor 204 and secured via a backing plate 211, such that the wheel 214 and backing plate 211 are sandwiched within the turbine 201 between the rotor 204 and the stator 202. A variety of other ways to attach the wheel to the rotor 204 without interfering with the blades 206 can be envisioned and are considered within the scope of the present disclosure.

The mechanical power transmission assembly 210 also includes a second profiled wheel 216, such as, for example, a second toothed sprocket, that is coupled to the gear assembly 232 of the mechanical power conversion assembly 230 and is configured to mesh with the belt 212. In various embodiments, the profiled wheel 216 is mounted to the gear assembly 232 adjacent the housing 236, such that the belt 212 attaches to the gear assembly 232 at a location that does not interfere with the gears of the assembly. Similar to the embodiment of FIGS. 1-5, a sealing member (see FIG. 5), such as, for example, a multiple-lip seal, may be used to keep water (e.g., rain, water from the body of fluid in which the floatation structure 220 floats, and/or other moisture) out of the housing 236 at the point where a rotating shaft of the profiled wheel 216 joins the housing 236. The belt 212, therefore, links the first profiled wheel 214 (which functions as a driving pulley of the belt drive assembly) to the second profiled wheel 216 (which functions as a driven pulley of the belt drive assembly), allowing rotation of the rotor 204 to be transmitted at a constant rotational speed, via the belt 212, to an input of the gear assembly 232.

As would be understood by those of ordinary skill in the art, the rim speed of the profiled wheel 214 and the turbine 201 will be the same for a given velocity of current. Therefore, the larger the turbine, the slower the rotation of the rotor 204 and the slower the revolutions per minute (RPMs) of the profiled wheel 214. As the generator 234 generally requires a high RPM to function properly (i.e., the generator generally requires a low torque, high speed input), embodiments of the present disclosure contemplate magnifying the RPMs of the profiled wheel 214 to produce higher RPMs in the profiled wheel 216 for input into the mechanical power conversion assembly 230, which also results in a lower wheel torque to the mechanical power conversion assembly 230. The profiled wheels 214 and 216 may, therefore, be sized to create a wheel ratio that functions to magnify the RPMs of the profiled wheel 216 (thereby reducing the magnification requirement of the gear assembly 232), while also preventing unnecessary wear in the belt 212 (e.g., as it rounds the profiled wheel 216). In various embodiments, for example, the profiled wheels 214 and 216 may be sized to create a wheel ratio between the profiled wheels (216:214) of about 8:1 to about 12:1. Those or ordinary skill in the art would understand that various ratios of sizes and profiles of the profiled wheels 214 and 216 can be selected to provide an appropriate wheel ratio for the transmission of power, based on a given application.

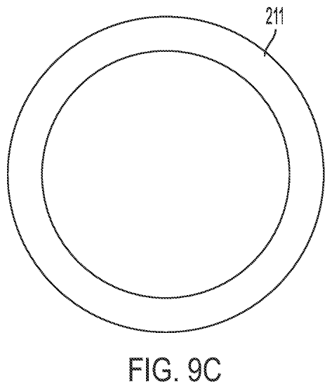

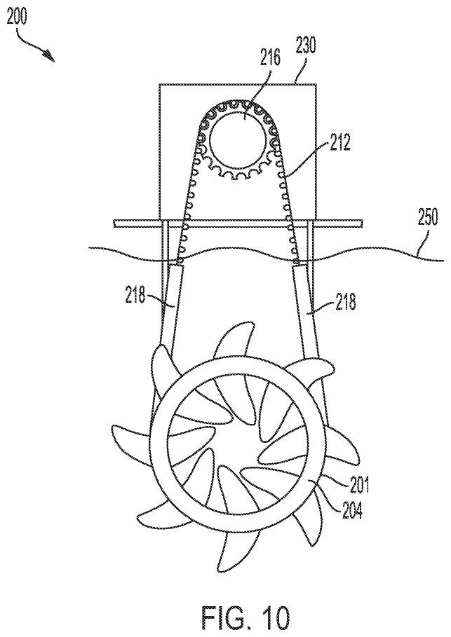

To protect the belt 212, for example, from debris within the fluid body (e.g., water), in various embodiments, the mechanical power transmission assembly 210 also includes a guard 218 that encases one or more portions of the belt 212. As illustrated in FIGS. 10 and 11, a pair of guards 218 may encase the portions of the belt 212 that are openly exposed to the fluid (i.e., below the surface 250 of the body of fluid) as it extends between the wheels 214 and 216. The guards 218 may be formed, for example, from a durable, non-corrosive material, such as, for example, stainless-steel that wraps around the belt 212 and is bolted together at connections 219 to form a protective housing around the belt 212. The guards 218 may be supported in a fixed position via, for example, struts 217 attached to the turbine 201 and the support structure 224.

Those of ordinary skill in the art will understand that the mechanical power transmission assembly 210 that utilizes the belt drive assembly including the belt 212, guards 218, and the profiled wheels 214 and 216 are exemplary only, and that various types, numbers, sizes and/or configurations of belts, guards, and/or wheels may be utilized within the systems and methods of the present disclosure (i.e., based on a particular application) to transmit the mechanical rotational energy collected by the turbine 201 to a location outside and above the surface of the body of fluid. For example, although in the embodiment of FIGS. 6-11, the mechanical power transmission assembly employs a profiled belt which engages a profiled wheel (sprocket), in another embodiment it is contemplated that the belt drive assembly can utilize a friction-locked system (i.e., where the belt is locked onto the wheels via frictional forces) comprising a smooth belt and smooth wheels. Embodiments of the present disclosure also contemplate utilizing belts, guards, and/or wheels made from various materials, including, for example, a metal, plastic, carbon fiber, and/or a composite material, which are formed via various method and/or techniques, including, for example, via additive manufacturing.

Furthermore, it will be understood that that the wheels 214 and 216 may be respectively coupled to the rotor 204 and the gear assembly 232 via any known methods and/or techniques and are not limited to the embodiment shown and described herein.

Accordingly, embodiments of the present disclosure contemplate hydroelectric energy systems having architectures that facilitate maintenance and life of electricity generation components. The use of mechanical power transmission assemblies, such as, CV axle mechanisms and belt drive assemblies, allows the gears and generators associated conversion of mechanical energy to electrical energy to be placed above the surface of the body of fluid in which the forces of the fluid flow are initially collected at the turbine, facilitating greater ease of access for any maintenance required, and reducing the risk of corrosion and damage to those electricity generation and mechanical energy conversion components.

CV axles/joints and belts have also been found to be robust and relatively inexpensive. Hydroelectric energy systems, utilizing such components, therefore also optimize the cost and efficiency of the electricity generation components of the system, thereby reducing the overall manufacture and maintenance costs of the system.

This description and the accompanying drawings that illustrate exemplary embodiments should not be taken as limiting. Various mechanical, compositional, structural, electrical, and operational changes may be made without departing from the scope of this description and the claims, including equivalents. In some instances, well-known structures and techniques have not been shown or described in detail so as not to obscure the disclosure. Furthermore, elements and their associated features that are described in detail with reference to one embodiment may, whenever practical, be included in other embodiments in which they are not specifically shown or described. For example, if an element is described in detail with reference to one embodiment and is not described with reference to a second embodiment, the element may nevertheless be included in the second embodiment.

It is noted that, as used herein, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Further, this description's terminology is not intended to limit the disclosure. For example, spatially relative terms—such as “upstream,” downstream,” “beneath,” “below,” “lower,” “above,” “upper,” “forward,” “front,” “behind,” and the like—may be used to describe one element's or feature's relationship to another element or feature as illustrated in the orientation of the figures. These spatially relative terms are intended to encompass different positions and orientations of a device in use or operation in addition to the position and orientation shown in the figures. For example, if a device in the figures is inverted, elements described as “below” or “beneath” other elements or features would then be “above” or “over” the other elements or features. Thus, the exemplary term “below” can encompass both positions and orientations of above and below. A device may be otherwise oriented (rotated 90 degrees or at other orientations) and the spatially relative descriptors used herein interpreted accordingly.

Further modifications and alternative embodiments will be apparent to those of ordinary skill in the art in view of the disclosure herein. For example, the systems may include additional components that were omitted from the diagrams and description for clarity of operation. Accordingly, this description is to be construed as illustrative only and is for the purpose of teaching those skilled in the art the general manner of carrying out the systems and methods of the present disclosure. It is to be understood that the various embodiments shown and described herein are to be taken as exemplary. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the scope of the present disclosure.

It is to be understood that the particular examples and embodiments set forth herein are non-limiting, and modifications to structure, dimensions, materials, and methodologies may be made without departing from the scope of the present disclosure. Other embodiments in accordance with the present disclosure will be apparent to those skilled in the art from consideration of the specification and practice of the invention disclosed herein. It is intended that the specification and examples be considered as exemplary only, with being entitled to their full breadth of scope, including equivalents.

What is claimed is:

1. A hydroelectric energy system comprising:
a turbine comprising a stator and a rotor, the rotor being disposed radially outward of the stator and being rotatable around the stator about an axis of rotation;
a mechanical power conversion assembly comprising a gear operably coupled to a generator; and
a mechanical power transmission assembly operably coupling the rotor to the gear,
wherein the rotor comprises a plurality of blades configured to rotate in response to fluid flow interacting with the plurality of blades,
wherein the mechanical power conversion assembly is at a location spaced from the axis of rotation by a distance larger than a radial sweep of the blades, and
wherein the mechanical power transmission assembly is configured to transmit the rotation of the rotor to the gear.

2. The system of claim 1, wherein the mechanical power transmission assembly comprises a constant velocity axle operably coupling the rotor and the gear.

3. The system of claim 2, wherein the constant velocity axle extends between the rotor and gear at angle of about 45 degrees or less.

4. The system of claim 3, wherein the constant velocity axle extends between the rotor and gear at angle of about 20 degrees or less.

5. The system of claim 2, wherein the mechanical power transmission assembly further comprises at least one constant velocity joint coupling the constant velocity axle to at least one of the gear or the rotor.

6. The system of claim 5, wherein the mechanical power transmission assembly comprises a first constant velocity joint coupling the constant velocity axle to the rotor and a second constant velocity joint coupling the constant velocity axle to the gear.

7. The system of claim 1, wherein the mechanical power transmission assembly comprises a belt operably coupling the rotor and the gear.

8. The system of claim 7, wherein the mechanical power transmission assembly further comprises a profiled wheel, the profiled wheel being mounted to the rotor and configured to mesh with the belt.

9. The system of claim 7, wherein the mechanical power transmission assembly further comprises a guard encasing one or more portions of the belt.

10. The system of claim 7, wherein the belt is formed from a metal, plastic, carbon fiber, and/or a composite material.

11. The system of claim 1, further comprising a floatation structure configured to support the turbine in a submerged position in a body of fluid generating the fluid flow, wherein the location of the mechanical power conversion assembly is above the body of fluid in the submerged position of the turbine.

12. The system of claim 11, wherein the floatation structure is configured to support the mechanical power conversion assembly at the location above the body of fluid.

13. The system of claim 11, wherein the floatation structure comprises a catamaran.

14. The system of claim 13, further comprising a hydraulic lift assembly coupled to the catamaran, the hydraulic lift assembly configured to support the turbine and moveable to position the turbine between the position submerged in the body of fluid and a position lifted above the body of fluid.

15. The system of claim 1, wherein the mechanical power conversion assembly is at a location spaced from the axis of rotation by a distance sufficient to enable the turbine to be submerged in a body of fluid comprising the fluid flow while the mechanical power conversion assembly is above a surface of the body of fluid.

16. A method of collecting hydroelectric energy, the method comprising:
supporting a turbine in a position submerged within a body of fluid comprising a fluid flow, the turbine comprising a rotor disposed radially outward of a stator, the rotor comprising blades extending radially outward;
rotating the rotor around the stator about an axis of rotation via the fluid flow interacting with the blades; and
transmitting the rotation of the rotor to a gear supported above the body of fluid, the gear being operatively coupled to a generator supported above the body of fluid.

17. The method of claim 16, wherein supporting the turbine in the position submerged within the body of fluid comprises suspending the turbine from a floatation structure.

18. The method of claim 17, further comprising supporting the gear and generator on the floatation structure.

19. The method of claim 16, wherein transmitting the rotation of the rotor to the gear comprises transmitting rotational mechanical energy from the rotor to the gear via a constant velocity axle.

20. The method of claim 16, wherein transmitting the rotation of the rotor to the gear comprises transmitting rotational mechanical energy from the rotor to the gear via a belt.

21. The method of claim 16, further comprising converting rotational mechanical energy from the gear to electrical energy via the generator.
